(19) United States
(12) Patent Application Publication
(10) Pub. No.: US 2006/0230874 A1
(43) Pub. Date: Oct. 19, 2006

(54) STEERING WHEEL AND METHOD OF MANUFACTURING

(75) Inventor: Roberto C. BUIOCCHI, Jundiai (BR)

Correspondence Address: FOLEY AND LARDNER LLP;SUITE 500, 3000 K STREET NW, WASHINGTON, DC, 20007, US

(73) Assignee: TAKATA-PETRI, INC.

(21) Appl. No.: 11/279,326

(22) Filed: Apr. 11, 2006

Related U.S. Application Data
(63) Continuation-in-part of application No. 11/254,728, filed on Oct. 21, 2005.
(60) Provisional application No. 60/671,513, filed on Apr. 15, 2005.

(51) Int. Cl. B62D 1/04

(52) U.S. Cl. 74/552

(57) ABSTRACT

The disclosed steering wheel and method of manufacturing may include the use of attachment points in the formation of the steering wheel armature. The steering wheel armature can comprise an inner hub, a plurality of spokes, an outer rim, and interface portions connecting the spokes to the outer rim. The method of manufacturing can comprise the steps of providing a mold with upper and lower sections, providing an outer rim, injecting a die cast material into the mold, and removing the outer rim and die cast material assembly.

### CROSS REFERENCE TO RELATED APPLICATIONS

This application is a continuation-in-part of U.S. patent application Ser. No. 11/254,728, filed Oct. 21, 2005, which claims priority to and the benefit of U.S. Provisional Patent Application Ser. No. 60/671,513, filed Apr. 15, 2005. The foregoing applications are incorporated by reference herein in its entirety.

### BACKGROUND

The present application relates generally to vehicle steering wheels In particular, to a method of manufacturing the steering wheel and, more particularly, the steering wheel armature.

Current steering wheel armatures are typically die cast magnesium, aluminum, or other suitable materials. For example, U.S. Pat. No. 6,193,267 discloses a steering wheel with a steering wheel armature that is preferably made of cast magnesium. The type of steering wheel armature in this patent is an integral one-piece structure in which a cover is molded over it. The armature comprised a hub portion and a rim portion with spokes connecting the hub portion to the rim portion. In some instances, the hub portion and spokes may be formed from a die cast material and connected to a tubular ring insert to form the steering wheel armature. An example is disclosed in U.S. Pat. No. 6,382,661 in which a steering wheel armature is disclosed with a centrally located hub portion, a circumferentially extending rim portion, and at least one spoke extending between the rim portion and the hub portion. In this patent, T-shaped knuckles are formed at the end of the spokes which encircle portions of the rim portion. This kind of conventional design is limited due to the relative strength of the tubular ring, which is typically steel. If the tubular rings do not have sufficient strength then problems can occur during the casting of the magnesia armature. In particular, the die casting pressure can cause problems.

### SUMMARY

According to one of the disclosed embodiments, a steering wheel is disclosed, which may comprise a steering wheel armature. The steering wheel armature may comprise an inner hub, a plurality of spokes, and an outer rim. The plurality of spokes can extend from the inner hub, can be made from a die cast material, and can be terminated at an interface portion. The outer rim can be connected to the plurality of spokes at the interface portions. In addition, the interface portions may encircle the outer rim along a longitudinal direction of the outer rim in which portions of the outer rim are exposed at the interface portions at a plurality of locations that are offset from each other. In one embodiment, the portions of the exposed rim can be offset in a radial manner and/or in a longitudinal manner, The outer rim can be a tube insert and/or made from steel. In addition, the die cast material can be aluminum, magnesium, or other suitable material.

In another disclosed embodiment, a method for manufacturing a steering wheel is disclosed. The method may comprise the steps of providing a mold with upper and lower sections, providing an outer rim, injecting a die cast material into the mold, and removing the outer rim and die cast material assembly.

The mold can include an inner hub recess and a plurality of spoke recesses that is in fluid communication with the inner hub recess. Also, the upper section of the mold can include a plurality of interface recesses in which each interface recess is paired with a corresponding interface recess in the lower section of the mold. Each pair of interface recesses may be in fluid communication with one spoke recess and each pair can include a plurality of attachment points protruding from the interface recesses. Furthermore, the attachment points within each pair of interface recesses are offset from each other.

When providing the outer rim, the outer rim can be inserted into the interface recesses of the mold sections and can make contact with the attachment points. When injecting a die cast material into the mold, the outer rim becomes connected to the plurality of spokes formed by the plurality of spoke recesses at interface portions formed at the interface recesses.

The attachment points in the interface recesses can be offset in a radial manner or in a longitudinal manner. In addition, the outer rim can be a tube insert and may be made from steel while the die cast material can be aluminum, magnesium, or other suitable material.

It is to be understood that both the foregoing general description and the following detailed descriptions are exemplary and explanatory only, and are not restrictive of the invention as claimed.

### BRIEF DESCRIPTION OF THE FIGURES

These and other features, aspects, and advantages of the present invention will become apparent from the following description, appended claims, and the accompanying exemplary embodiments shown in the drawings, which are briefly described below.

FIG. 1 shows an exploded perspective view of a steering wheel assembly.

FIG. 2 shows a cross-sectional view of a steering wheel assembly without the outer cover.

FIG. 3 shows a perspective view of a steering wheel armature.

FIG. 4 shows a cross-sectional view of the upper and lower sections of the mold viewed from the position where section C-C- of the steering wheel armature of FIG. 3 is formed.

FIG. 5A shows a cross-sectional view of a portion of the upper and lower sections of the mold viewed from the position where section D-D of the steering wheel armature of FIG. 3 is formed. FIG. 5B shows a cross-section view of a portion of the upper and lower sections of the mold viewed from the position where section E-E of the steering wheel armature of FIG. 3 is formed.

FIG. 6 shows a top plan view of the interface portion that connects a portion of the outer rim and a portion of a spoke at an interface portion.

FIG. 7 shows a cross-sectional view of section A-A of FIG. 4.

FIG. 8 shows a cross-sectional view of section B-B of FIG. 4.

FIG. 9 shows a plan view of the outer rim placed inside the lower section of the mold before the die casting process.

FIG. 10 show the plan view of the lower and upper sections of the mold without the outer rim.

### DETAILED DESCRIPTION

An embodiment is directed to providing an improved steering wheel manufacturing method. The steering wheel may include a tubular ring insert or rim that is held in position during the die casting process in which magnesium (or other suitable material) is cast. The ring is held at attachment points that are offset in order to control the “centering” of the ring during the magnesium (or other suitable material) casting process. As a result, the armature exhibits improved performance and consistence in quality.

Through use of the offset attachment points, the position of the tubular insert ring can be controlled, which can result in increased flexibility of tubular ring designs; improved steering wheel performance and stress analysis; and improved quality and production.

Referring now to the drawings, various disclosed embodiments will be described below.

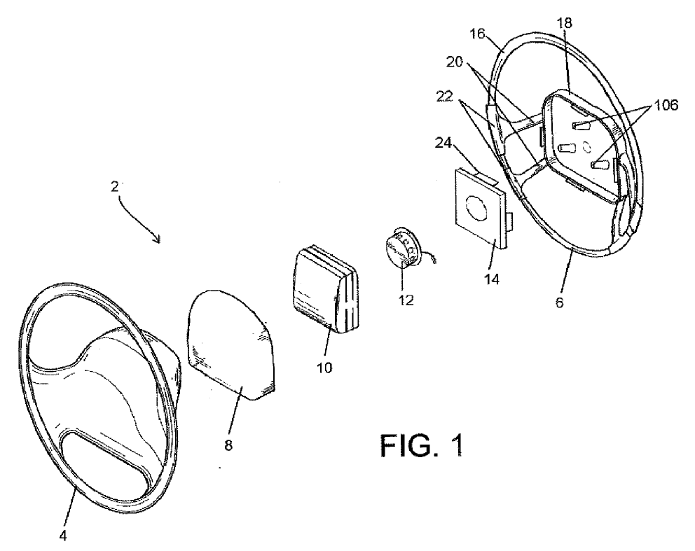

FIG. 1 shows an exploded perspective view of a steering wheel assembly 2 according to an embodiment of the present invention. The steering wheel assembly 2 may comprise an outer cover 4, an inner cover 8, an airbag 10, an inflator 12, a support 14, and a steering wheel armature 6.

The outer cover 4 can be an integral one-piece structure that is molded about the steering wheel armature 6 and the inner cover 8. The outer cover 4 covers the outer rim 16, the inner hub 18, and the spokes 20 of the steering wheel armature 6. Furthermore, the outer cover 4 has a continuous outer surface which extends uninterruptedly over the inner cover 8. The outer cover 4 may be made of a homogenous urethane material. The cover 54 is molded about the inner cover 8 and comprises a tear seam (not shown), which may not be visible at the surface of the outer cover 4 that faces the driver. The tear seam is used as the doorway through which the airbag will deploy through so as to protect the driver in an emergency, such as a vehicular accident.

Although the outer cover 4 is made of an integral one-piece structure, alternatively, the outer cover may be made from a plurality of sections. For example, the outer cover 4 may comprise a first cover portion that covers the outer rim 16 and the spokes 20 of the armature 6 and a second cover portion that covers the inner hub 18 of the armature 6 and the inner cover 8.

The steering wheel armature 6 and the method of manufacturing the steering wheel armature will be discussed in detail below. Briefly, the steering wheel armature 6 may comprise an outer rim 16, an inner hub 18, and a plurality of spokes 20. The inner hub and spokes may be made from a die cast material, such as aluminum or magnesium. The spokes project out from the inner hub toward interface portions 22, which substantially encircle the outer rim 16 along portions of the outer rim in he longitudinal direction. The outer rim 16 can be a tubular insert and may be made of a steel tube.

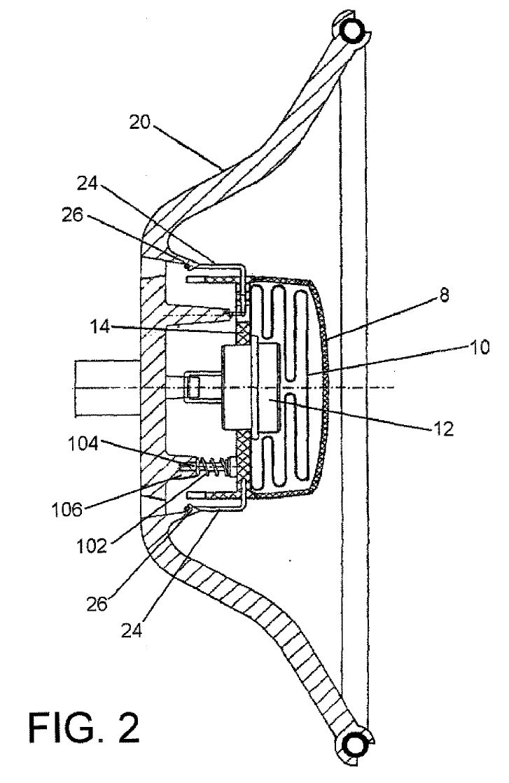

FIG. 2 shows a cross-sectional view of the steering wheel assembly 2 without the outer cover 4. FIG. 2 shows that the airbag 10 is supported by the support 14. The support 14 connects to the armature 6 through the use of latching hooks 26 that hook onto wire hoops 24, which are attached to the support 14. The inflator 12, which is used to inflated the airbag 10, is fastened to the support 14. The distance between the support 14 and the steering wheel armature 6 is defined by helical springs 102 as spacer elements. Arranged within the helical springs 102 are pins 104, which engage in depressions 106 on the steering wheel armature 6. Thus, the airbag 10 is prevented from being displaced laterally with respect to the steering wheel armature 6.

The inner cover 8 houses the airbag 10 after is has been folded and mounted on the support 14 but before it is covered by the outer cover 4. The inner cover may have tear seams (not shown) in which the airbag will be capable of bursting through upon deployment during a crash event. Alternatively, the inner cover 8 may be eliminated from the assembly if desired. Although it is not depicted in FIGS. I or 2, the support 14 and the inner hub 18 are configured to house and support all the necessary devices and electronics for the deployment of the airbag or for the operation of a horn (not shown). For example, one type of horn that can be used in this embodiment can be found in U.S. Pat. No. 6,675,675, which is incorporated by reference herein. In addition, other conventional elements can be used with the steering wheel, such as those elements shown in U.S. Pat. No. 6,193,267, which is incorporated by reference herein.

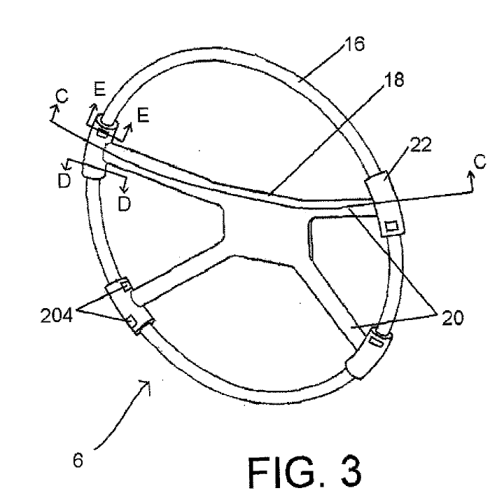

FIG. 3 shows an embodiment of the steering wheel armature 6. As described above, the steering wheel armature 12 includes an inner hub 18, a circumferentially extending rim 16, and a plurality of spokes 20 extending between the inner hub 18 and the outer rim 16. The inner hub 16 can be centrally located or any other suitable location within the outer rim 16. The shape and contour of the inner hub can be varied depending upon the use, type, and location of the airbag assembly and other electronics mounted in the steering wheel, for example, as shown in FIGS. 1 and 2. The outer rim 16 can be a hollow tube having an internal passage 202 as shown in FIGS. 7 and 8. The hollow tube can be made from steel or any other suitable material.

The spokes 20 of the steering wheel armature 6 and the inner hub 18 can be made from a die cast material, such as an aluminum or magnesium material. The plurality of spokes 20 and the inner hub 18 can be cast together as an integral one-piece structure. As seen in FIG. 3, there can be four spokes 20 extending between the inner hub 18 and the outer rim 16 but any number of spokes could be used, for example two, three, or five. In addition, the spokes 20 in FIG. 3 can have a generally cylindrical shape and be similar in construction. Alternatively, the spokes 20 can take any suitable shape and the individual spokes do not necessarily need to be the same shape.

Each of the spokes 20 may include an interface portion 22 that encircles portions of the outer rim 16 along a longitudinal direction of the outer rim 16. As shown in FIGS. 1 and 3, the interface portion can be substantially T-shaped but other shaped can be used as well.

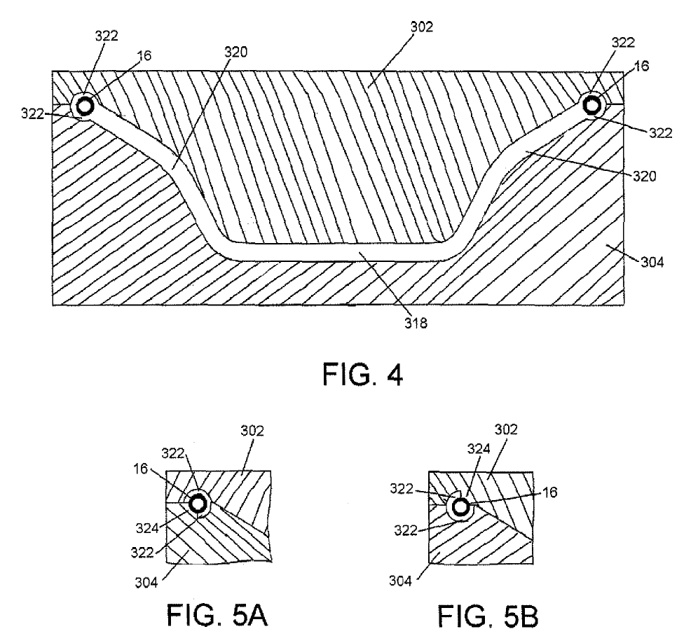

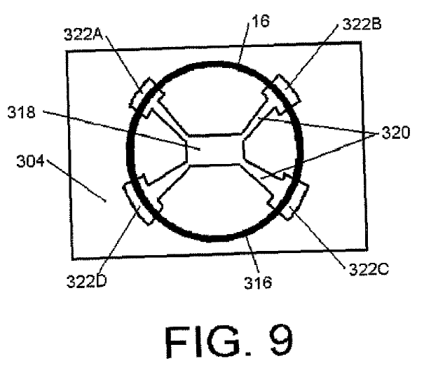

One of the potential problems with casting the spoke portion around the outer rim 16 is that the outer rim may be placed off-center in the mold. To help counteract this potential problem, the mold in which the casting process takes place may include a plurality of attachment points. These attachment points can be offset from each other to better control the centering of the outer rim 16 during the casting process. FIG. 4 shows a cross-section of the mold in which the part of the steering wheel armature 6 along section C-C of FIG. 3 is formed. The mold includes an upper section 302 and a lower section 304. The upper and lower sections may include a plurality of recesses including a central hub recess 318, individual spoke recesses 320 that extend from the central hub recess, and interface recesses 322 that terminate at the ends of the individual spoke recesses. As can be seen in FIG. 4 at the interface recesses 322, the outer rim 16 is suspended across these recesses. FIG. 9 shows that the outer rim 16 is positioned into place by rim recesses 316. The rim recesses 316 are able to secure the outer rim at the edge of the interface recesses 322 but not at the section of the outer rim that is toward the center of the interface recess 320. To better centralize the outer rim 16 during the casting process, attachment points 324 arc located in the interface recesses 322. These attachment points protrude from the interface recesses 322 and support and align the outer rim 16 during the casting process. To better optimize the aligning and supporting functions of the attachment points 324, the attachment points are offset from each other.

To support the outer rim 16 during the casting process, the attachment points 324 abut against the outer rim 16 as it is placed in the mold as seen in FIG. 5A and 5B. FIG. 5A is the cross-section of the portion of the mold in which section D-D of the armature in FIG. 3 will be formed while FIG. 5B is the cross-section of the portion of the mold in which section E-E of the armature in FIG. 3 would be formed.

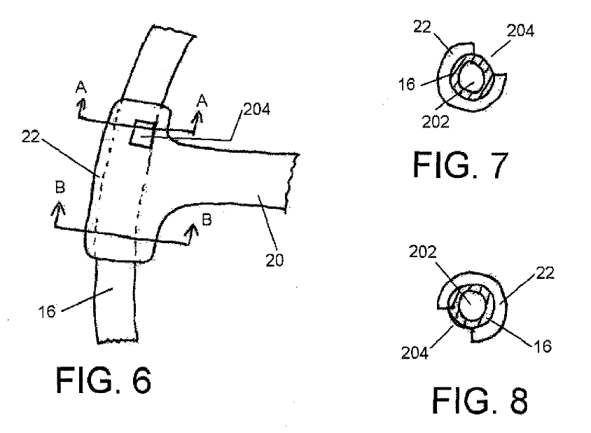

The abutment of the attachment points 324 against the outer rim 16 will result in portions of the outer surface of the outer rim 16 that is encircled within the interface portion 22 to be exposed, for example, as indicated by the exposed portions 204 shown in FIG. 6. These exposed portions 204 are offset due to the fact that the attachment points 324 are offset.

FIG. 6 is a top plan view of the interface portion 22 that connects the outer rim 16 and the spoke portion 20. As previously described, the outer rim 16 can be tubular with an inner passage 202. FIG. 7 is a cross-sectional view through section A-A of FIG. 6. FIG. 8 is a cross-sectional view through section B-B of FIG. 6.

As can be seen in FIGS. 5B, there was one attachment point 324 that was abutting against the upper right-hand side of the outer rim 16 which resulted in the exposed portion 204 in the interface portion 22 as seen in FIG. 7. In a similar manner, FIG. 5A shows that another attachment point 324 was abutting against the lower left-hand side of the outer rim 16 which resulted another exposed portion 204 in the interface portion 22 as seen in FIG. 8. Similar exposed areas can also be found in the other interface portions 22 attached along the outer rim 16.

The attachment points can take a variety of shapes and sizes. In addition, the number of attachment points located within the interface recesses of the upper and lower sections of the mold can be varied. For example, if two attachment points are used when forming one interface portion, the attachment points may be offset from each other in the longitudinal direction of the outer rim, the radial direction of the outer rim, or a combination of the two,

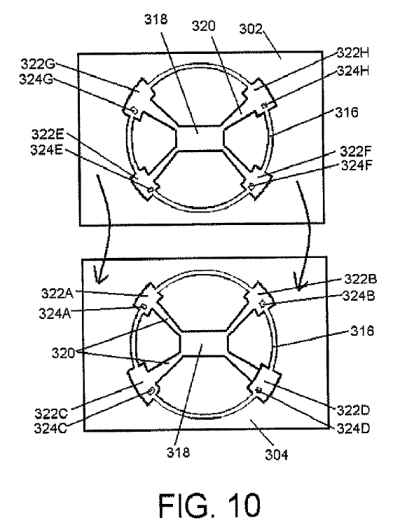

FIG. 9 shows a outer rim 16 located within the rim recess 316 of the lower section 304 of the mold. This embodiment of the lower mold includes a central inner hub recess 318, a plurality of spoke recesses 320, and a plurality of interface recesses 322A though 322D. The lower section 304 of the mold has attachment points 324A, 324B, 324C, and 324D located in the interface recesses 322A, 322B, 322C, and 322D, respectively, as seen in FIG. 10 in which the outer rim 16 is removed for illustrative purposes.

In the embodiment shown in FIG. 10, the upper section 302 also includes an inner hub recess 318, a plurality of spoke recesses 320, and a plurality of interface recesses 322E through 322H that correspond to the inner hub recess 318, the plurality of spoke recesses 320, and the plurality of interface recesses 322A through 322D in the lower mold 304. The interface recess 322A of the lower section of the mold corresponds to the interface recess 322E of the upper section; the interface recess 322B corresponds to the interface recess 322F; the interface recess 322C corresponds to the interface recess 322G; and the interface recess 322D corresponds to the interface recess 322H. In addition, the upper section 302 of the mold includes attachment points 324E through 324H located in their respective interface recesses 322E through 322H. The attachment points 324A and 324E will be offset from each other once the upper section 302 of the mold is placed on top of the lower section 304 of the mold. In a similar manner, the attachment points 324B and 324F will be offset from each other; the attachment points 324C and 324G will be offset from each other; and the attachment points 324D and 324H will be offset from each other.

According to various embodiments, the upper and lower sections of the molds can have any combination of recesses necessary to form the steering wheel armature 6 depending on the shape and contours of the desired steering wheel armature. For example, the upper section 302 of the mold may have the recesses for the inner hub 18, the spokes 20, and the interface portions 22 while the lower section 304 of the mold merely has recesses for just the interface portions 22. Another example is that the lower section can have recesses for the inner hub 18, the spokes 20, and the interface portions 22 but the upper mold only has recesses for the spokes 20 and the interface portions 22. Furthermore, the design of the upper and lower sections of the mold can be varied as well, for example, the entire outer rim may not be encapsulated by the mold but only the portions of the outer rim 16 necessary to mold the die casting material onto it may be encapsulated by the mold.

The method of manufacturing a steering wheel may include providing the mold with upper and lower sections 302 and 304. As seen in FIG. 10, the mold may include an inner hub recess 318 and a plurality of spoke recesses 320 that is in fluid communication with the inner hub recess 318. The upper section 302 of the mold may include a plurality of interface recesses 322E-322H in which each interface recess is paired with a corresponding interface recess 322A-322B in the lower section 304 of the mold. Each pair of interface recesses is in fluid communication with one spoke recess and each pair includes a plurality of attachment points 324A-H protruding from the interface recesses in which the attachment points within each pair of interface recesses are offset from each other. An outer rim is provided and is inserted into a rim recess 316 and each pair of interface recesses. As a result, the outer rim 16 makes contact with the attachment points in each pair of interface recesses. A die cast material is injected into the mold such that the outer rim becomes connected to a plurality of spokes formed by the plurality of spoke recesses at interface portions formed at the interface recesses. The combined assembly of the die cast material and outer rim is removed from the mold.

After the combined assembly is removed, the steering wheel armature can be included in a steering wheel assembly, such as that provided in FIG. 1. For example, the steering wheel armature can be mounted on a steering column, have an airbag and/or horn assembly attached to it, and/or can at least be partially covered by a steering wheel cover.

By using attachment points that are offset from each other within the interface recesses of upper and lower sections of the mold, the steering wheel can be better centralized during the casting process. The benefits from providing a better centralization of the outer rim can allow increased flexibility in the design of the outer rim, for example, other tubular shapes and dimensions can be used. In addition, improved quality of the steering wheel armature can be achieved as well as improved stress analysis and steering wheel performance.

Given the disclosure, one versed in the art would appreciate that there may be other embodiments and modifications within the scope and spirit of the invention. Accordingly, all modifications attainable by one versed in the art from the present disclosure within the scope and spirit of the present invention are to be included as further embodiments of the present invention, The scope of the present invention is to be defined as set forth in the following claims.

What is claimed is:

1. A steering wheel comprising:
a steering wheel armature including: an inner hub; a plurality of spokes extending from the inner hub made from a die cast material and terminating at an interface portion; and an outer rim connected to the plurality of spokes at the interface portions;
wherein the interface portions encircle the outer rim along a longitudinal direction of the outer rim, wherein portions of the outer rim are exposed at the spoke interface at a plurality of locations that are offset from each other.

2. The steering wheel according to claim 1, wherein the portions of the exposed rim are offset in a radial manner.

3. The steering wheel according to claim 1, wherein the portions of the exposed rim are offset in a longitudinal manner

4. The steering wheel according to claim 1, wherein the outer rim is a tube insert.

5. The steering wheel according to claim 1, wherein the outer rim is steel.

6. The steering wheel according to claim 1, wherein the die cast material is aluminum or magnesium.

7. The steering wheel according to claim 1, further comprising at least a portion of the steering wheel armature is covered by an outer cover.

8. The steering wheel according to claim 7, further comprising an airbag assembly mounted on the steering wheel armature.

9. A method for manufacturing a steering wheel comprising:
providing a mold with upper and lower sections, wherein the mold includes an inner hub recess and a plurality of spoke recesses that is in fluid communication with the inner hub recess, wherein the upper section of the mold includes a plurality of interface recesses in which each interface recess is paired with a corresponding interface recess in the lower section of the mold, wherein each pair of interface recesses is in fluid communication with one spoke recess and each pair includes a plurality of attachment points protruding within each pair of interface recesses, wherein the attachment points are offset from each other;
providing an outer rim that is inserted into the interface recesses and make contact with the attachment points;
injecting a die cast material into the mold such that the outer rim becomes connected to a plurality of spokes formed by the plurality of spoke recesses at interface portions formed at the interface recesses; and
removing an assembly comprising the die cast material and rim from the mold.

10. The method according to claim 9, wherein the attachment points in each pair of interface recesses are offset in a radial manner.

11. The method according to claim 9, wherein the attachment points in each pair of interface recesses are offset in a longitudinal manner.

12. The method according to claim 9, wherein the outer rim is a tube insert.

13. The method according to claim 9, wherein the outer rim is steel.

14. The method according to claim 9, wherein the die cast material is aluminum or magnesium.
